(19) United States
(12) Patent Application Publication
(10) Pub. No.: US 2010/0290147 A1
(43) Pub. Date: Nov. 18, 2010

(54) APPARATUS AND METHOD FOR PROCESSING MAGNETIC TAPE MEDIA

(76) Inventors: Patrick J. Shevlin, Butler, PA (US); James E. Burd, Saxonburg, PA (US); Robert J. Strauss, Pittsburgh, PA (US)

Correspondence Address: K&L GATES LLP, 210 SIXTH AVENUE, PITTSBURGH, PA, 15222-2613, US

(21) Appl. No.: 12/677,485

(22) PCT Filed: Sep. 11, 2008
(86) PCT No.: PCT/US08/76044

§ 371 Date: Jun. 28, 2010

Related U.S. Application Data
(60) Provisional application No. 60/993,309, filed on Sep. 11, 2007.

(51) Int. Cl. G11B 5/02

(52) U.S. Cl. 360/55; G9B/5.026

(57) ABSTRACT

An apparatus including a read head and at least two tape guides. The read head detects a magnetic field representative of information recorded on magnetic tape media, and the at least two tape guides guide the magnetic tape media on a path adjacent a read surface of the read head. The at least two tape guides are positioned to contact a substrate of the magnetic tape media and to maintain a non-zero distance between the path and the read surface.

### TECHNICAL FIELD OF THE INVENTION

This application is directed generally and in various embodiments to an apparatus and a method for processing magnetic tape media.

### BACKGROUND

Magnetic tape media for recording and reproducing analog information is known and has been used extensively by the recording industry and others over the last several decades. Magnetic tape media is typically constructed of a magnetic layer bonded to a substrate by a binder layer. The magnetic layer may include, for example, magnetic oxide particles or other suitable type of magnetic particles formed into one or more tracks, and the binder layer may include a polymer binder. During the recording process, the magnetic tape media is passed over a write head which generates a time-varying magnetic field based on the analog information to be recorded. The magnetic field alters the polarity of magnetic particles, thereby “writing” the information to the magnetic tape media. The recorded information is subsequently reproduced by passing the magnetic tape media over a read head which detects a time-varying magnetic field created by the relative motion of the magnetic particles. The read head typically includes a coil which generates an analog signal representative of the recorded information in response to the time-varying magnetic field.

Magnetic tape media is not suitable for storing analog information indefinitely, however. In particular, a variety of processes cause the binder layer and/or the substrate to physically degrade over time. Of particular concern is a process termed “hydrolysis” wherein moisture absorbed by the binder layer causes its deterioration and delamination from the substrate. Sometimes referred to as “sticky tape syndrome,” this condition may cause a portion of the magnetic layer and/or binder layer to shed and clog the read head and/or other components (e.g., tape guides and rollers) of the tape transport mechanism during reproduction, possibly rendering the affected portions of the tape media permanently unplayable and/or causing severe damage to the tape transport mechanism.

In certain cases, magnetic tape media affected by hydrolysis may be “repaired” to an extent by heating the magnetic tape media for a period of time to stabilize the binder layer so that the recorded information may be reproduced and transferred to another recording medium. Although this “baking” process is generally effective, it nonetheless may be desirable to first ascertain and review the tape media content to determine if the time and expense of restoration is warranted. The need to ascertain and review the tape media content without baking is especially desirable in cases where a large amount of tape media of unknown content is being considered for restoration.

### SUMMARY

This application discloses an apparatus including a read head and at least two tape guides. The read head detects a magnetic field representative of information recorded on magnetic tape media, and the at least two tape guides guide the magnetic tape media on a path adjacent a read surface of the read head. The at least two tape guides are positioned to contact a substrate of the magnetic tape media and to maintain a non-zero distance between the path and the read surface.

### DESCRIPTION OF THE FIGURES

FIG. 1 illustrates a magnetic tape media transport mechanism according to an embodiment of the present invention;

FIGS. 2A and 2B illustrate top views of a head stack mounting assembly according to various embodiments of the present invention;

FIG. 3 illustrates a front view of the head stack mounting assembly of FIG. 2A;

FIG. 4 illustrates a top view of the head stack mounting assembly of FIG. 2A, and

FIGS. 5A and 5B illustrate top and front views, respectively, of the record head of the head stack mounting assembly.

### DESCRIPTION

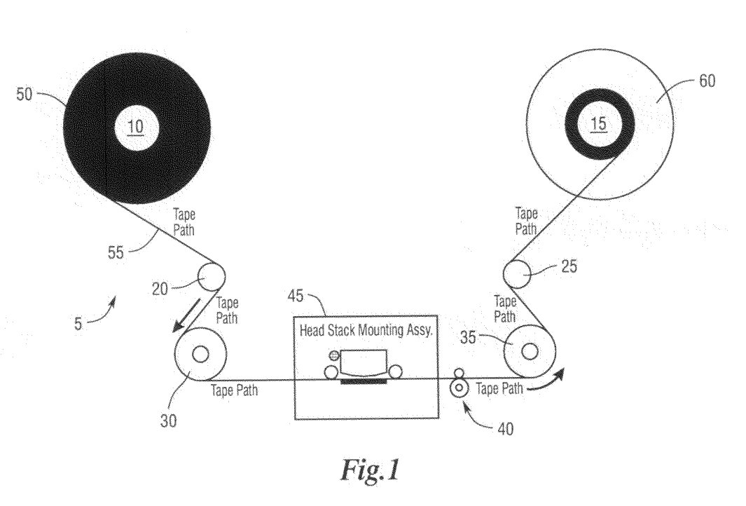

FIG. 1 illustrates a magnetic tape media transport mechanism 5 according to one embodiment of the present invention. As shown, the transport mechanism 5 may employ a reel-to-reel configuration and include a supply tape reel spindle 10, a take-up tape reel spindle 15, a first tape guide 20, a second tape guide 25, a first roller guide 30, a second roller guide 35, a capstan/pinch roller assembly 40, and a head stack mounting assembly 45. Spindle 10 is configured to receive a supply tape reel 50 containing magnetic tape media 55 to be processed by the transport mechanism 5, and spindle 15 is configured to receive a take-up tape reel 60 for receiving the magnetic tape media 55 subsequent to being processed. According to various embodiments, the magnetic tape media 55 may contain analog audio content, such as music or other sounds. In certain embodiments, the magnetic tape media 55 may be degraded by the effects of hydrolysis.

The first and second tape guides 20, 25, the first and second roller guides 30, 35, the capstan/pinch roller assembly 40, and the head stack mounting assembly 45 collectively define a tape path through which the magnetic tape media 55 is transported. At the beginning of the tape path, as shown in FIG. 1, magnetic tape media 55 is unwound from the supply tape reel 50 and introduced into the transport mechanism 5 such that the magnetic layer of the magnetic tape media 55 is outwardly guided over the first tape guide 20. From the first tape guide 20, the substrate of the magnetic tape media 55 is outwardly guided over the first roller guide 30. The magnetic tape media 55 is next passed through the head stack mounting assembly 45 and then through the capstan/pinch roller assembly 40. From the capstan/pinch roller assembly 40, the substrate of the magnetic tape media 55 is outwardly guided over the second roller guide 35. From the second roller guide 35, the magnetic layer of the magnetic tape media 55 is outwardly directed over the second tape guide 25 and onto the take-up tape reel 60. A DC motor (not shown) may rotate the capstan of the capstan/pinch roller assembly 40 such that the magnetic tape media 55 is metered through the tape path at an appropriate speed. Additionally, spindle 10 and/or the spindle 15 may be motorized such that the magnetic tape media 55 is properly tensioned and fed/collected by reels 50, 60.

In certain embodiments, the tape guides 20, 25 may be stationary pins constructed of a suitably non-magnetic material, such as, for example, stainless steel or ceramic. First and second roller guides 30, 35 may also be constructed from a non-magnetic material and configured to rotate at a speed substantially identical to that of the magnetic tape media 55 passing over their respective surfaces. Rotation of the roller guides 30, 35 in this manner reduces friction between the roller guide surfaces and the magnetic layer of the magnetic tape media 55. In cases where the binder layer has deteriorated due to hydrolysis, the reduced friction advantageously decreases shedding of the magnetic layer. Although two tape guides 20, 25 and two roller guides 30, 35 are depicted in FIG. 1, it will be appreciated that in other embodiments additional tape guides and roller guides may be provided depending on, for example, the length of the tape path through the transport mechanism 5.

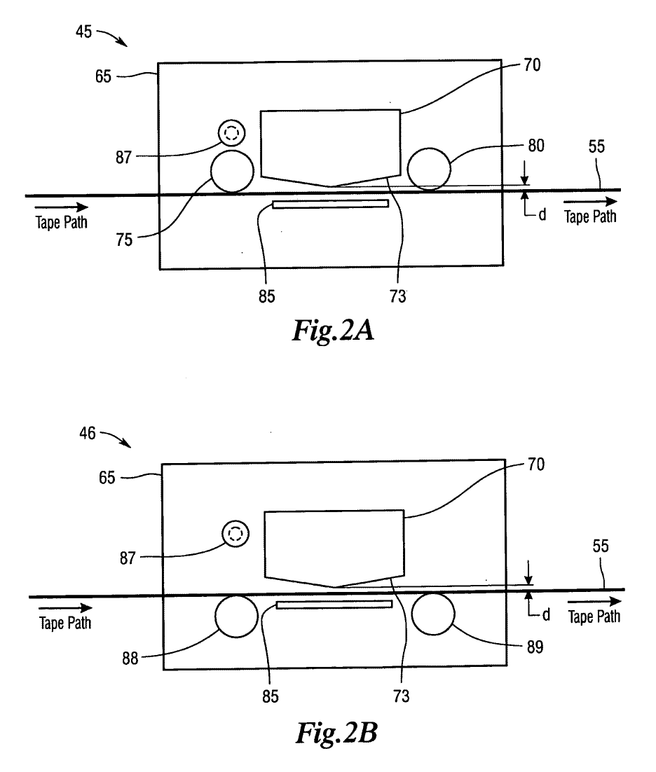

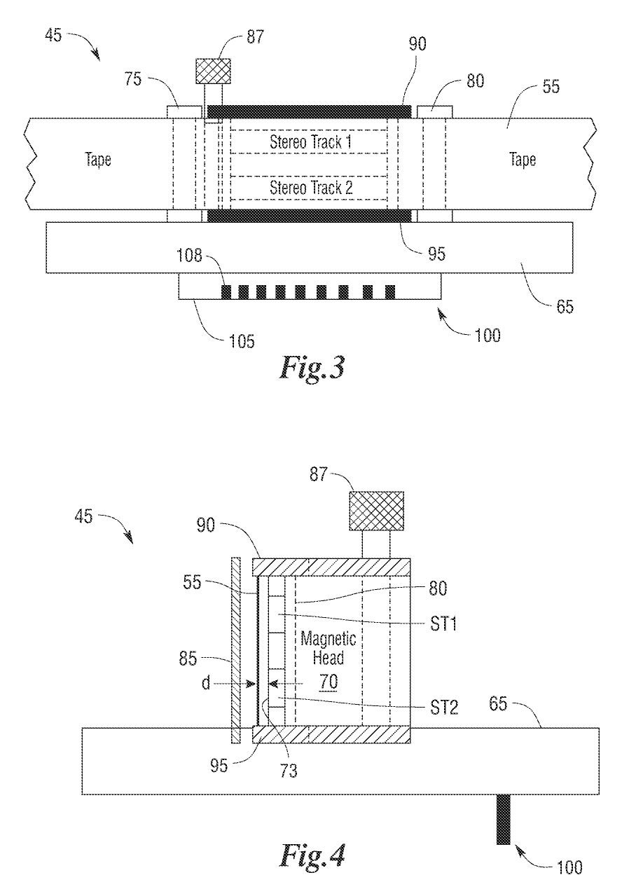

FIGS. 2A, 3 and 4 illustrate top, front and side views, respectively, of the head stack mounting assembly 45 of FIG. 1. As shown, the head stack mounting assembly 45 includes a plate 65 or other suitable structure onto which a read head 70, a first roller guide 75, a second roller guide 80, and an electromagnetic shield 85 are mounted. As discussed below in connection with FIGS. 3 and 4, the head stack mounting assembly 45 may be of a modular construction such the assembly 45 is removable from the transport mechanism 5.

The first and second roller guides 75, 80 are disposed adjacent opposite sides of the read head 70 and contact the magnetic layer of the magnetic tape media 55 such that the media 55 is guided between a read surface 73 of the read head 70 and the electromagnetic shield 85. Importantly, the first and second roller guides 75, 80 are positioned such that their contact with the magnetic tape media 55 properly aligns the magnetic tape media 55 with the read surface 73 while at the same time preventing the magnetic layer of the media 55 from contacting the read surface 73. The non-zero distance introduced between the path of the magnetic tape media 55 and the read surface 73 is indicated in FIG. 2A by distance “d”. The head stack mounting assembly 45 thus significantly differs from conventional headstack mounting assemblies in which the magnetic layer is made to contact the read head. Because contact between the magnetic tape media 55 and the read surface 73 of the read head 70 is prevented by suitably positioning the first and second roller guides 75, 80, friction between the media 55 and the read surface 73 that is characteristic of conventional headstack assemblies is altogether eliminated. Advantageously, in cases where the binder layer of the magnetic tape media 55 has deteriorated due to hydrolysis, elimination of friction in this manner prevents shedding of the magnetic layer and clogging of the read head 70 that would otherwise result if a conventional headstack mounting assembly were to be used.

The non-zero distance “d” may generally be selected to be as small as possible such that read head 70 signal output losses are minimized while at the same time generally preventing its contact with the magnetic tape media 55. In certain embodiments, for example, the non-zero distance between the path of the magnetic tape media 55 and the read surface may be about 25.4 to 254 μm, and preferably 150 to 200 μm. The non-zero distance “d” may be such that, in certain cases, fluctuations in the tension of the magnetic tape media 55 or other conditions may cause the magnetic layer of the media 55 to occasionally contact the read surface 73. It is expected that such contact will be infrequent and will not significantly effect the operation of the read head 70 in cases in which the media 55 is susceptible to magnetic layer shedding.

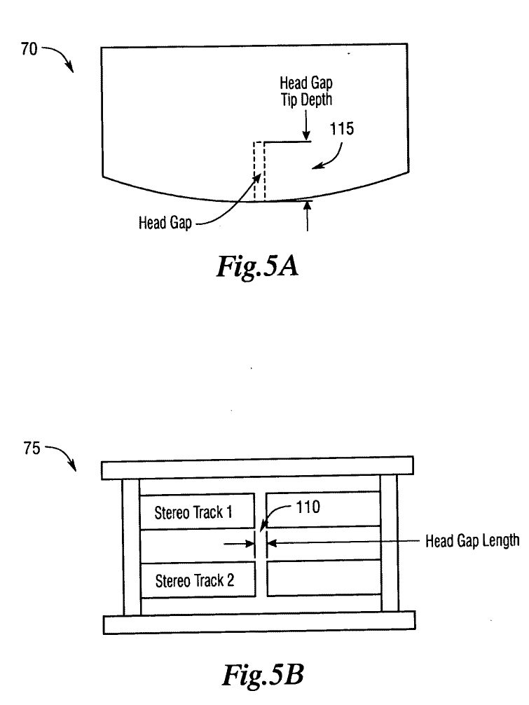

According to various embodiments, the read head 70 may be fabricated from laminated layers of a mu-metal alloy, a ferric base material, or other suitable material and designed to compensate, either partially or entirely, output losses that might otherwise result from the introduction of the gap between the magnetic tape media 55 and the read surface 73. In certain embodiments, for example, one or more parameters of the read head 70 may be selected so as to maximize its useful signal output. Such parameters may include, for example, the gap length 110 (FIG. 5B) of the read head 70 and the gap tip depth 115 (FIG. 5A) of the read head 70. In one embodiment, for example, the gap length 110 may be approximately 100 μm and the gap tip depth 115 may be approximately 127 μm. In certain embodiments, the gap tip depth 115 may be selected to be as small as possible without introducing significant resonance effects, thus maximizing the coil size (i.e., the number of coil turns) of the read head 70 and, correspondingly, the signal gain of the read head 70. Other selectable parameters of the read head 70 may include, for example, the inductance of the read head 70 and the amount of field strength induced across the coil of the read head 70. In one embodiment, for example, the inductance of the read head 70 may be approximately 1 H.

Although the figures illustrate a stereo read head for reading two tracks, one of ordinary skill in the art will recognize that the read head 70 may generally be configured to read any number of tracks arranged in any configuration or format. Additionally, although only one read head 70 is shown in the figures, it will be appreciated that the head stack mounting assembly 45 may include multiple read heads 70 depending upon, for example, the number and arrangement of tracks contained on the magnetic tape media 55.

It will further be appreciated that the read head 70 having the necessary parameters for compensating the introduction of the gap may be custom-fabricated or fabricated by modifying an existing conventional read head. In the latter case, for example, a conventional read head may be recontoured to modify the gap depth 115 and/or other parameters as necessary.

In addition or as an alternative to the selection of read head 70 parameters as described above, parameters of the transport mechanism 5, such as the velocity of the magnetic tape media 55 relative to read head 70, may be selected to maximize the useful signal output.

In certain embodiments, the head stack mounting assembly 45 may include a preamplifier circuit (not shown) in communication with the read head 70 for suitably increasing the strength of the signal generated by the coil of the read head 70 prior to subsequent signal processing stages. In other embodiments, the preamplifier circuit may be externally located with respect to head stack mounting assembly 45 (e.g., at another location within the transport mechanism 5 or within signal processing equipment in communication with the transport mechanism 5).

The electromagnetic shield 85 is positioned opposite the read surface 73 and adjacent the substrate layer of the magnetic tape media 55. The electromagnetic shield 85 functions to reduce stray electromagnetic noise emitted from within and/or external to the transport mechanism 5 that might otherwise interfere with the desired operation of the read head 70.

The first and second roller guides 75, 80 may be constructed from a non-magnetic material and configured to rotate at a speed substantially identical that of the magnetic tape media 55 passing over their respective surfaces. As with roller guides 30, 35, rotation of the roller guides 75, 80 in this manner reduces friction between the roller guide surfaces and the magnetic layer of the magnetic tape media 55, thus decreasing the incidence magnetic layer shedding. Although two roller guides 75, 80 are depicted in FIG. 2A, it will be appreciated that in other embodiments additional roller guides may be provided depending on, for example, the length of the tape path through the head stack mounting assembly 45.

As shown in FIG. 1, the head stack mounting assembly 45 may further include an azimuth adjustment screw 87 for adjusting the angle of the read head 70 relative to the direction of travel of the magnetic tape media 55.

FIG. 2B illustrates a top view of a head stack mounting assembly 46 according to another embodiment of the present invention. The head stack mounting assembly 46 is identical to the assembly 45 of FIG. 2A with the exception that the first and second roller guides 75, 80 are replaced by a first tape guide 88 and a second tape guide 89 positioned to contact the substrate of the magnetic tape media 55 so as to maintain the gap between the media 55 and the read surface 73. The tape guides 88, 89 may be stationary pins constructed of a suitably non-magnetic material, such as, for example, stainless steel or ceramic. It is expected that the first and second tape guides 88, 89 will impart a greater degree of stability to the magnetic tape media 55 compared to that of roller guides 70, 80 of the embodiment of FIG. 2A. In the embodiment of FIG. 2B, although raised areas on the substrate resulting from media splices may occasionally cause the media 55 to contact the read surface 73, such contact is expected to be infrequent and will not adversely affect operation of the read head 70. Although two tape guides 88, 89 are depicted in FIG. 2B, it will be appreciated that in other embodiments additional tape guides may be provided depending on, for example, the length of the tape path through the head stack mounting assembly 46.

As shown in FIGS. 3 and 4, the head stack mounting assembly 45 may also include a top edge guide 90 and a bottom edge guide 95. The guides 90, 95 may be positioned between the first and second roller guides 75, 80 and include a smooth surface for slidingly contacting the top and bottom edges, respectively, of the magnetic tape media 55, thereby increasing the lateral stability of the magnetic tape media 55 as it traverses the head stack mounting assembly 45. In certain embodiments, the guides 90, 95 may be fabricated from a ceramic or other nonmagnetic material.

As further shown in FIGS. 3 and 4, the head stack mounting assembly 45 may include a head stack mounting connector 100. The head stack mounting connector 100 may include, for example, a male edge connector 105 including electrical contacts 110 and configured for receipt by an oppositely-gendered receptacle (not shown) of the transport mechanism 5. It will be appreciated that other suitable types of electrical connectors (e.g., pinned connectors) of either gender may alternatively be used for the mounting connector 100. Electrical components of the head stack mounting assembly 45, such as the read head 70, may thus be suitably interfaced with electrical components (e.g., amplifiers, signal processing circuitry, etc.) of the transport mechanism 5 via the connector 100. The connector 100 may also operate to mechanically retain the head stack mounting assembly 45 within the transport mechanism 5. In certain embodiments and as noted above, the head stack mounting assembly 45 may be of a modular construction such that it may be “unplugged” and removed from the transport mechanism 5 for cleaning/servicing or replacement with a head stack mounting assembly of a different configuration.

The examples presented herein are intended to illustrate potential and specific implementations of the present invention. It can be appreciated that the examples are intended primarily for purposes of illustration of the invention for those skilled in the art. No particular aspect or aspects of the examples is/are necessarily intended to limit the scope of the present invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art and because they do not facilitate a better understanding of the present invention, a discussion of such elements is not provided herein.

Any element expressed herein as a means for performing a specified function is to encompass any way of performing that function including, for example, a combination of elements that perform that function. Furthermore the invention, as defined by such means-plus-function claims, resides in the fact that the functionalities provided by the various recited means are combined and brought together in a manner as defined by the appended claims. Therefore, any means that can provide such functionalities may be considered equivalents to the means shown herein.

While various embodiments of the invention have been described herein, it should be apparent that various modifications, alterations and adaptations to those embodiments may occur to persons skilled in the art with the attainment of some or all of the advantages of the present invention. For example, although the transport mechanism 5 of the exemplary embodiments presented above is based on a reel to reel configuration, it is contemplated that other embodiments may utilize other tape configurations (e.g., cassette tapes). The disclosed embodiments are therefore intended to include all such modifications, alterations and adaptations without departing from the scope and spirit of the present invention.

What is claimed is:

1. An apparatus, comprising:
a read head to detect a magnetic field representative of information recorded on magnetic tape media; and
at least two tape guides to guide the magnetic tape media on a path adjacent a read surface of the read head, wherein the at least two tape guides are positioned to contact a substrate of the magnetic tape media and to maintain a non-zero distance between the path and the read surface.

2. The apparatus of claim 1, wherein each of the at least two guides is a stationary tape guide.

3. The apparatus of claim 1, wherein the non-zero distance between the path and the read surface is about 25.4 to 254 μm.

4. The apparatus of claim 3, wherein the non-zero distance between the path and the read surface is about 150 to 200 μm.

5. The apparatus of claim 1, wherein read head comprises a gap length of about 100 μm.

6. The apparatus of claim 1, wherein read head comprises a gap depth of about 127 μm.

7. The apparatus of claim 1, wherein read head comprises an inductance of about 1 H.

8. The apparatus of claim 1, comprising a head stack assembly, wherein the read head and the at least two tape guides are mounted to the head stack assembly.

9. The apparatus of claim 8, comprising a magnetic tape transport mechanism, wherein the magnetic tape transport mechanism removably contains the head stack assembly.

10. The apparatus of claim 1, comprising a preamplifier circuit in communication with the read head for processing a signal generated by the read head.

11. The apparatus of claim 1, comprising an electromagnetic shield positioned opposite the read head such that the path is disposed between the electromagnetic shield and the read head.

12. The apparatus of claim 1, comprising an azimuth adjustment screw in communication with the read head, the azimuth adjustment screw for adjusting an angle of the read head relative to a direction of travel of the magnetic tape media.

13. The apparatus of claim 1, comprising a top edge guide and a bottom edge guide for slidingly contacting a top edge and a bottom edge, respectively, of the magnetic tape media.

14. A method for processing degraded magnetic tape media, the method comprising:
receiving at least a portion of the magnetic tape media through a tape path, wherein at least a portion of the tape path is adjacent a read surface of a read head, and wherein the tape path and the read surface define a gap therebetween; and
generating an analog signal representative of information recorded on the magnetic tape media as the magnetic tape media passes the read surface.

15. The method of claim 14, comprising processing the analog signal to identify content of the magnetic tape media.
